(19) United States
(12) Patent Application Publication
(10) Pub. No.: US 2011/0206895 A1
(43) Pub. Date: Aug. 25, 2011

(54) CARBON FIBER LAMINATE SKI OR SNOWBOARD WITH METAL RIB CORE DAMPENING SYSTEM

(75) Inventors: Peter George Turner, Eden, UT (US); Stephan Rodman Drake, Boulder, CO (US)

(73) Assignee: Drake Powderworks LLC, McMinnville, OR (US)

(21) Appl. No.: 13/014,588

(22) Filed: Jan. 26, 2011

Related U.S. Application Data
(60) Provisional application No. 61/298,293, filed on Jan. 26, 2010.

(51) Int. Cl. B32B 15/04; B32B 9/04; B32B 5/00; B32B 3/26; B32B 3/12

(52) U.S. Cl. 428/116; 428/457; 428/408; 428/332; 428/319.1

(57) ABSTRACT

A ski or snowboard may be constructed of an elongate body having a front end and a rear end. The body further includes a core with a top side and a bottom side. At least one layer of carbon fiber is laminated to the core at the top side and the bottom side. Also, at least one metal rib extends along the core, with the metal rib being sandwiched between the layers of carbon fiber.

### CROSS REFERENCES TO RELATED APPLICATIONS

This application is a nonprovisional application claiming the benefit of U.S. Provisional Patent Application No. 61/298,293, filed Jan. 26, 2010, the complete disclosure of which is herein incorporated by reference.

### BACKGROUND OF THE INVENTION

This invention generally relates to ski and snowboards, and in particular to skis and snowboards that are constructed from carbon fiber laminates with metal ribs.

Today, very few carbon skis or snowboards are manufactured. One reason for this is because they are often unwieldy in use. As such, this invention provides carbon skis that addresses this and other issues.

### BRIEF SUMMARY OF THE INVENTION

One aspect of the invention is the placement of one or more metal ribs into the structure of a carbon ski or snowboard without adding any noticeable weight. The metal contributes to the stress loads and moves with the flexural strain of the ski. Using the metal rib in the core shear layer allows the use of very small amounts of low strength metal.

The invention is in contrast to placing metal in the top and bottom bending stress layers, which results in very high strength and thick sections of metal that add substantial weight to the ski.

The use of metal ribs with carbon laminates provides results in performance that are not evident in a fiberglass or metal laminate ski with metal ribs. The specific mating of carbon laminates with lightweight metal ribs achieves a previously unattainable alchemy of performance that combines lightweight, power, and dampening without compromise on any level.

In one particular embodiment, the invention provides an exemplary ski or snowboard that comprises an elongate body having a front end and a rear end. The body further includes a core with a top side and a bottom side. At least one layer of carbon fiber is laminated to the core at the top side and the bottom side. Also, at least one metal rib extending along the core, with the metal rib being sandwiched between the layers of carbon fiber.

In one particular aspect, the ski or snowboard includes a pair of spaced apart metal ribs. In some cases, these ribs can be located near the sides of the elongate body on opposite sides of a center line of the ski or snowboard. In another aspect, multiple carbon fiber layers are laminated to the top side and the bottom side of the core.

The metal rib may extend either partially along the length of the core or fully along the length of the core, or can extend in discrete segments. In one aspect, the rib defines a height that extends between the layers of carbon fiber and a thickness that is orthogonal to the height. The thickness may be in the range from about 0.1 mm to about 3 mm.

In a further aspect, the core is constructed of a material such as wood, foam, a honeycomb material or the like. Also, the metal forming the rib may be a metal such as steel, aluminum, titinal, magnesium or the like.

In yet another aspect, a top layer may be positioned on top of the layer of carbon fiber on the top side. This top layer may be constructed of a plastic material. Also, a bottom layer may be positioned adjacent the layer of carbon fiber on the bottom side. The bottom layer may be contracted of polyethylene.

In one particular embodiment, the invention provides an exemplary ski or snowboard that comprises an elongate body having a front end, a rear end and a central axis extending between the front end and the rear end. The body further includes a core with a top side, a bottom side and two side walls. At least one layer of carbon fiber is laminated to the core at the top side and the bottom side. A pair of metal ribs extend along the core generally parallel to the central axis and sandwiched between the layers of carbon fiber. One of the metal ribs is adjacent one side of the elongate body and the other metal rib is adjacent the other side of the elongate body.

### BRIEF DESCRIPTION OF THE DRAWINGS

FIG. 1 is a cutaway view of one section of a ski according to the invention.

FIG. 2 is a top view of the ski of FIG. 1.

FIG. 3 is a top view of a snowboard according to the invention.

### DETAILED DESCRIPTION OF THE INVENTION

The invention provides exemplary skis and snowboards that are constructed to take into consideration three design qualities. The first is that the ski or snowboard be lightweight so that it may reduce rider fatigue and allow for faster and more responsive turn transitions. The second is power which provides reactivity, energy transfer, and responsiveness of the ski or snowboard to rider input. Third is vibration dampening that makes for better ride quality and stability at speed.

Embodiments of the invention utilize carbon fiber in combination with metal ribs to address each of these design features. Carbon fiber, when employed as the sole laminate in a ski or snowboard construction provides substantial improvement in both the “lightweight” and “power” categories of traditional fiberglass and metal ski or snowboard designs. Skis and snowboards built with pure carbon laminates enjoy weight reductions that can be as much as 30%, while the high modulus of the carbon fiber leads to torsional stiffness and responsiveness gains that can increase as much as 40% when compared to the standard fiberglass and metal constructions that currently dominate ski and snowboard construction. However, skis or snowboards built with pure carbon fiber laminates are very difficult to manufacture.

Carbon skis are inherently very light based on the material's low material density. While this enhances the “lightweight” and “power” attributes of the ski, it also makes a carbon ski susceptible to being deflected while hitting small objects or changes in snow surface conditions. Carbon structures are also not able to damp vibrations relative to fiberglass and other composite structures. This property gives a carbon fiber construction ski a tremendous amount of energy and reactivity when responding to changes in snow surface conditions. While the reactivity is generally a positive force in the “power” attribute of a ski, the same reactivity can be a detriment to the “dampening” attribute—often making the ski feel nervous or lead to a sense of lack of control in hard or uneven snow.

Stability and “dampening” can be augmented by adding weights that create a smoother ride. However, this can lead to a heavier ski. One useful dampening material is metal, either aluminum, titinal, or steel, which contrary to their natural vibration characteristics, provide a “silky” and “smooth” quality to the ride of skis and snowboards when used as a laminate. Metal laminate skis and snowboards are used in ski racing, mostly because of their “dampening” qualities. However, metal laminate skis are invariably heavy.

Adding metal to the top and bottom laminates of a ski makes a ski feel very damp and stable, but often with a “dead” that lacks the rebound and responsiveness of a carbon ski. It frequently adds weight to the ski but some of the undefined properties of metal improve the performance of the ski. Adding metal to both top and bottom structural skins puts the metal in the highest stress zones from flexural bending of the ski. High strength aluminum or steel alloys are required to resist these bending stresses. The amount of metal material adds substantially to the weight of the ski.

The invention utilizes vertically-oriented metal ribs (as opposed to metal laminates) that are added to the core structure. As such, the metal ribs are not part of the structural top and bottom skins of the ski or snowboard. Instead, the metal ribs are part of the core and are used in combination with one or more layers of a carbon fiber laminate ski. Since the core is in shear only the stresses are very low relative to the top and bottom structural skins or facings. Very small amounts of metal of a very low strength can be used. But the stabilizing properties of the metal are readily observed in the performance of the ski while adding only negligible weight.

Hence, one advantage of using vertical metal core ribs in combination with a carbon ski is the improved damping and stability of the ski. This is accomplished by employing the dampening properties of metals within a ski or snowboard without adding a substantial or even barely measureable amount of weight to an already very lightweight and responsive carbon fiber ski. Accordingly, an important aspect of the invention is the combination of vertically-oriented metal ribs and carbon laminates.

In certain embodiments, vertical metal ribs (steel, aluminum, titinal, magnesium, etc.) are laminated within the wooden or foam core of the skis. While a variety of metals may be used to construct the ribs, use of materials such as carbon and fiberglass do not provide the necessary characteristics as described herein. For example, mating ribs constructed out of carbon does not dampen the ski because carbon is not a damp feeling material. The desired results discussed above are preferably achieved with the use of metal ribs such as those constructed of aluminum, steel, titanium, magnesium, or other metals mated specifically with a carbon laminate construction. The ribs extend vertically from the top to the bottom carbon structural layers and are integrally bonded to them. The extremely high modulus of the metal compared to the wood, foam, or other low density core materials means the shear stresses are carried through the metal to a much greater degree than represented by the comparative cross sectional areas of the two different materials.

The metal ribs can be about 0.1 mm to about 1 mm or more in thickness. The ski or snowboard can also include a single rib or multiple separately layered ribs. The number of ribs can be increased up to a point where the mass of the ski becomes too high and unmanageable to ski properly because of added weight. In one particular arrangement, a ski that is about 120 mm wide may have two 0.2 mm ribs that are spaced apart from each other. These two ribs represent only about 0.33% of the area of the ski. These ribs may be constructed of aluminum that has a modulus of 10×10⁶ psi which is at least 10 times that of a typical core material. The ribs carry over 3% of the shear load despite being only 0.3% of the area. This allows the very small amount of aluminum material to contribute its favorable metal properties to the overall properties of the ski to a much greater degree than one would otherwise expect. Yet the weight addition of two full length strips is only 10.2 grams in a carbon ski that weighs 1830 grams without ribs, representing only a 0.9% increase in ski weight. This weight difference is not detectable by the skier and is less than the normal weight variation in the ski molding and manufacturing process.

The vertical ribs can be placed full length as in one preferred embodiment of this invention. They can, however, be placed strategically in the tip, the tail, or central areas of the ski or in combinations thereof. The ribs can be placed very close to the edges and follow the sidecut or be parallel strips running parallel to the ski centerline. Further, the ribs can be placed near the center or positioned far apart from the centerline. One particular embodiment uses two 0.2 mm thick strips placed 75 mm apart running from the tip to the tail ends of the ski and integrally bonded to the core and the top and bottom carbon structural layers.

When these vertical ribs are placed in the core where they become a structural part of the ski, carrying the stresses and following the strain or flex of the ski, the ribs cause a dramatic effect and improvement in ski stability. For example, skis made and tested with two 0.2 mm carbon vertical ribs demonstrated much improved stability especially on hard and variable snow conditions as compared to traditional fiberglass skis.

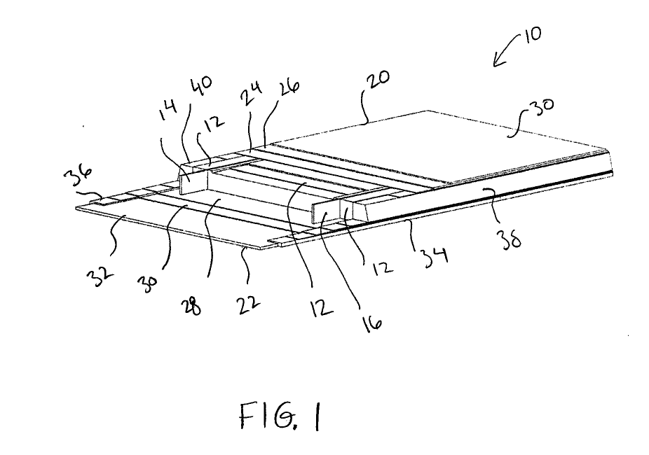

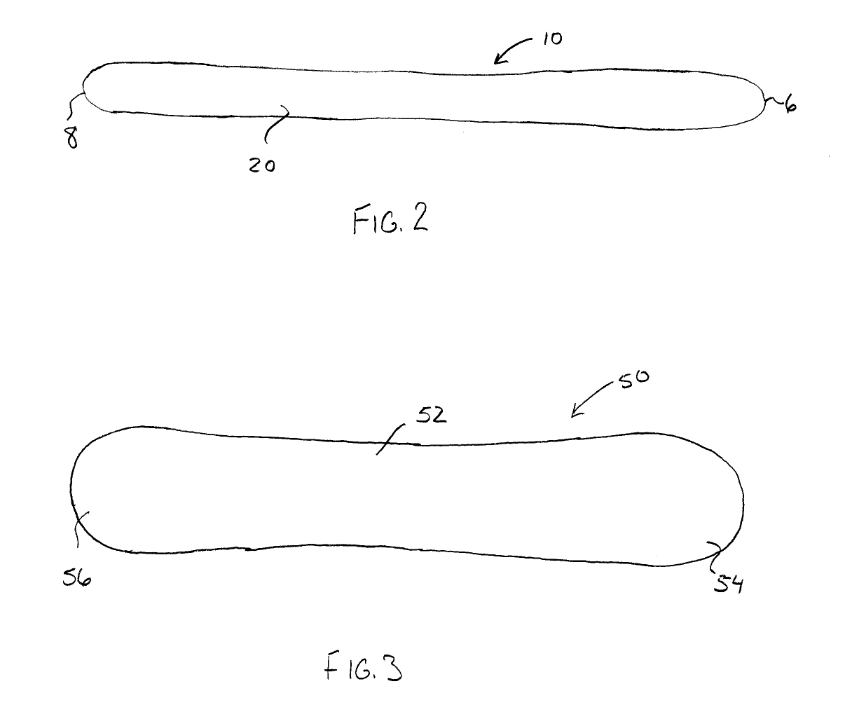

Referring now to FIGS. 1 and 2, one embodiment of a ski 10 will be shown. For convenience of illustration, FIG. 1 shows a cut-away section of ski 10. It will be appreciated that the construction of the ski as shown in FIG. 1 may extend along the full length of the ski. Also, although shown as a ski, it will be appreciated that a snowboard may be constructed in a similar manner as described hereinafter. Ski 10 has a front end 6, a rear end 8 and is constructed of a core 12 that may be made from a variety of materials know in the art. For example, core 12 may be constructed of wood, foam, a honeycomb material, or the like. Extending through core 12 are a pair of metal ribs 14 and 16. Ribs 14 and 16 are vertically oriented relative to the top and bottom surfaces of the ski body. Ribs 14 and 16 may extend only part way along the length of ski 10 or may extend the full length. In some cases, ribs 14 and 16 could extend intermittently along the length of ski 10. Further, although shown with two ribs, a single rib could be used, or more than two ribs could be used. Metal ribs 14 and 16 may be constructed of a variety of metal materials, such as steel, aluminum, titinal, magnesium, and the like. Metal ribs 14 and 16 will typically have a thickness in the range from about 0.1 mm to about 1 mm. However, in some cases, the thickness may be in range from about 0.1 mm to about 3 mm, and more typically about 2 mm.

Ski 10 also has a top side 20 and a bottom side 22. Laminated to top side 20 are layers of carbon fibers 24 and 26. Layers 24 and 26 are placed directly on top of core 12. Typically, the orientation of the fibers within layer 24 will be different from those in layer 26. Bottom side 22 also includes two laminated layers of carbon fibers, referred to as layers 28 and 30. The fibers in these layers may also be in different directions. For convenience of construction, a top layer 30 may be positioned over carbon fiber layer 26. A wide variety of materials may be used for top layer 30, such as a plastic material. Bottom 22 further includes a bottom layer 32 that is placed against the skiing surface. Bottom layer 32 is constructed of a base material, such as polyethylene, as is know in the art. Also, metal edges 34 and 36 may be placed about the edges of layer 32. Conveniently, sidewalls 38 and 40 may also be used to complete the construction. Types of sidewall materials that may be used include plastics, such as ABS, wood, and the like.

FIG. 3 illustrates an embodiment of a snowboard 50 that may also include a core similar to that described in connection with the ski of FIGS. 1 and 2. Snowboard 50 comprises a board body 52 having a front 54 and a rear 56. One or more vertically-oriented metal ribs may extend some or all of the length of body 52 (from front 54 to rear 56). These metal ribs may be constructed as previously described in connection with other embodiments.

The invention has now been described in detail for purposes of clarity and understanding. However, it will be appreciated that certain changes and modifications may be practiced within the scope of the appended claims.

What is claimed is:

1. A ski or snowboard comprising:
an elongate body having a front end and a rear end, the body further including a core with a top side and a bottom side;
at least one layer of carbon fiber laminated to the core at the top side and the bottom side;
at least one metal rib extending along the core, the metal rib being sandwiched between the layers of carbon fiber.

2. A ski or snowboard as in claim 1, further comprising a pair of spaced apart metal ribs.

3. A ski or snowboard as in claim 1, further comprising multiple carbon fiber layers laminated to the top side and the bottom side of the core.

4. A ski or snowboard as in claim 1, wherein the metal rib extends either partially along the length of the core or fully along the length of the core.

5. A ski or snowboard as in claim 1, wherein the rib defines a height that extends between the layers of carbon fiber and a thickness that is orthogonal to the height, and wherein the thickness is in the range from about 0.1 mm to about 3 mm.

6. A ski or snowboard as in claim 1, wherein the core is constructed of a material selected from a group consisting of wood, foam, and a honeycomb material.

7. A ski or snowboard as in claim 1, wherein the metal forming the rib is from a group of metals consisting of steel, aluminum, titinal, and magnesium.

8. A ski or snowboard as in claim 1, further comprising a top layer positioned on top of the layer of carbon fiber on the top side, wherein the top layer is constructed of a plastic material.

9. A ski or snowboard as in claim 1, further comprising a bottom layer positioned adjacent the layer of carbon fiber on the bottom side, wherein the bottom layer is contracted of polyethylene.

10. A ski or snowboard as in claim 2, wherein each rib is positioned adjacent a side of the elongate body.

11. A ski comprising:
an elongate body having a front end, a rear end and a central axis extending between the front end and the rear end, the body further including a core with a top side, a bottom side and two side walls;
at least one layer of carbon fiber laminated to the core at the top side and the bottom side;
a pair of metal ribs extending along the core generally parallel to the central axis and sandwiched between the layers of carbon fiber, wherein one of the metal ribs is adjacent one side of the elongate body and the other metal rib is adjacent the other side of the elongate body.

12. A ski as in claim 11, further comprising multiple carbon fiber layers laminated to the top side and the bottom side of the core.

13. A ski as in claim 11, wherein the metal ribs extend either partially along the length of the core or fully along the length of the core.

14. A ski as in claim 11, wherein each rib defines a height that extends between the layers of carbon fiber and a thickness that is orthogonal to the height, and wherein the thickness is in the range from about 0.1 mm to about 3 mm.

15. A ski as in claim 11, wherein the core is constructed of a material selected from a group consisting of wood, foam, and a honeycomb material.

16. A ski as in claim 11, wherein the metal forming the ribs is from a group of metals consisting of steel, aluminum, titinal, and magnesium.

17. A ski as in claim 11, further comprising a top layer positioned on top of the layer of carbon fiber on the top side, wherein the top layer is constructed of a plastic material.

18. A ski as in claim 1, further comprising a bottom layer positioned adjacent the layer of carbon fiber on the bottom side, wherein the bottom layer is contracted of polyethylene.
